(19) United States
(12) Patent Application Publication
(10) Pub. No.: US 2008/0094419 A1
(43) Pub. Date: Apr. 24, 2008

(54) Generating and displaying spatially offset sub-frames

(76) Inventors: Stan E. Leigh, Corvallis, OR (US); William J. Allen, Corvallis, OR (US); Richard Aufranc, Corvallis, OR (US); Arnold W. Larson, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/585,376

(22) Filed: Oct. 24, 2006

(51) Int. Cl. G06K 9/32; G09G 5/00

(52) U.S. Cl. 345/660; 382/300

(57) ABSTRACT

A method of displaying an image with a display device includes receiving image data for the image. Sub-frame shifting parameters are identified based on at least one of image characteristics of the image, system status information, and user-defined parameters. A first plurality of sub-frames corresponding to the image data is generated based on the identified sub-frame shifting parameters. The first plurality of sub-frames is displayed at a first plurality of spatially offset sub-frame display positions using the identified shifting parameters, thereby producing a displayed image.

### CROSS-REFERENCE TO RELATED APPLICATIONS

This application is related to U.S. patent application Ser. No. 10/103,394, filed on Mar. 20, 2002, entitled METHOD AND APPARATUS FOR IMAGE DISPLAY, issued as U.S. Pat. No. 7,019,736; U.S. patent application Ser. No. 10/213,555, filed on Aug. 7, 2002, entitled IMAGE DISPLAY SYSTEM AND METHOD; U.S. patent application Ser. No. 10/242,195, filed on Sep. 11, 2002, entitled IMAGE DISPLAY SYSTEM AND METHOD, issued as U.S. Pat. No. 7,034,811; U.S. patent application Ser. No. 10/242,545, filed on Sep. 11, 2002, entitled IMAGE DISPLAY SYSTEM AND METHOD; U.S. patent application Ser. No. 10/631,681, filed Jul. 31, 2003, entitled GENERATING AND DISPLAYING SPATIALLY OFFSET SUB-FRAMES; U.S. patent application Ser. No. 10/632,042, filed Jul. 31, 2003, entitled GENERATING AND DISPLAYING SPATIALLY OFFSET SUB-FRAMES; U.S. patent application Ser. No. 10/672,845, filed Sep. 26, 2003, entitled GENERATING AND DISPLAYING SPATIALLY OFFSET SUB-FRAMES; U.S. patent application Ser. No. 10/672,544, filed Sep. 26, 2003, entitled GENERATING AND DISPLAYING SPATIALLY OFFSET SUB-FRAMES; U.S. patent application Ser. No. 10/697,605, filed Oct. 30, 2003, entitled GENERATING AND DISPLAYING SPATIALLY OFFSET SUB-FRAMES ON A DIAMOND GRID; U.S. patent application Ser. No. 10/696,888, filed Oct. 30, 2003, entitled GENERATING AND DISPLAYING SPATIALLY OFFSET SUB-FRAMES ON DIFFERENT TYPES OF GRIDS; U.S. patent application Ser. No. 10/697,830, filed Oct. 30, 2003, entitled IMAGE DISPLAY SYSTEM AND METHOD; U.S. patent application Ser. No. 10/750,591, filed Dec. 31, 2003, entitled DISPLAYING SPATIALLY OFFSET SUB-FRAMES WITH A DISPLAY DEVICE HAVING A SET OF DEFECTIVE DISPLAY PIXELS; U.S. patent application Ser. No. 10/768,621, filed Jan. 30, 2004, entitled GENERATING AND DISPLAYING SPATIALLY OFFSET SUB-FRAMES; U.S. patent application Ser. No. 10/768,215, filed Jan. 30, 2004, entitled DISPLAYING SUB-FRAMES AT SPATIALLY OFFSET POSITIONS ON A CIRCLE; U.S. patent application Ser. No. 10/821,135, filed Apr. 8, 2004, entitled GENERATING AND DISPLAYING SPATIALLY OFFSET SUB-FRAMES; U.S. patent application Ser. No. 10/821,130, filed Apr. 8, 2004, entitled GENERATING AND DISPLAYING SPATIALLY OFFSET SUB-FRAMES; U.S. patent application Ser. No. 10/820,952, filed Apr. 8, 2004, entitled GENERATING AND DISPLAYING SPATIALLY OFFSET SUB-FRAMES; U.S. patent application Ser. No. 10/864,125, filed Jun. 9, 2004, entitled GENERATING AND DISPLAYING SPATIALLY OFFSET SUB-FRAMES; U.S. patent application Ser. No. 10/868,719, filed Jun. 15, 2004, entitled GENERATING AND DISPLAYING SPATIALLY OFFSET SUB-FRAMES, U.S. patent application Ser. No. 10/868,638, filed Jun. 15, 2004, entitled GENERATING AND DISPLAYING SPATIALLY OFFSET SUB-FRAMES; U.S. patent application Ser. No. 11/072,045, filed Mar. 4, 2005, entitled GENERATING AND DISPLAYING SPATIALLY OFFSET SUB-FRAMES; U.S. patent application Ser. No. 11/221,271, filed Sep. 7, 2005, entitled GENERATING AND DISPLAYING SPATIALLY OFFSET SUB-FRAMES; U.S. patent application Ser. No. 11/480,101, filed Jun. 30, 2006, entitled GENERATING AND DISPLAYING SPATIALLY OFFSET SUB-FRAMES. Each of the above U.S. patent applications is assigned to the assignee of the present invention, and is hereby incorporated by reference herein.

### BACKGROUND

A conventional system or device for displaying an image, such as a display, projector, or other imaging system, produces a displayed image by addressing an array of individual picture elements or pixels arranged in horizontal rows and vertical columns. A resolution of the displayed image is defined as the number of horizontal rows and vertical columns of individual pixels forming the displayed image. The resolution of the displayed image is affected by a resolution of the display device itself as well as a resolution of the image data processed by the display device and used to produce the displayed image.

Typically, to increase a resolution of the displayed image, the resolution of the display device as well as the resolution of the image data used to produce the displayed image needs to be increased. Increasing the resolution of the display device, however, increases cost and complexity of the display device.

### SUMMARY

One form of the present invention provides a method of displaying an image with a display device. The method includes receiving image data for the image. Sub-frame shifting parameters are identified based on at least one of image characteristics of the image, system status information, and user-defined parameters. A first plurality of sub-frames corresponding to the image data is generated based on the identified sub-frame shifting parameters. The first plurality of sub-frames is displayed at a first plurality of spatially offset sub-frame display positions using the identified shifting parameters, thereby producing a displayed image.

### BRIEF DESCRIPTION OF THE DRAWINGS

FIG. 1 is a block diagram illustrating an image display system according to one embodiment of the present invention.

FIGS. 2A-2C are schematic diagrams illustrating the display of two sub-frame images according to one embodiment of the present invention.

FIGS. 3A-3E are schematic diagrams illustrating the display of four sub-frame images according to one embodiment of the present invention.

FIGS. 4A-4E are schematic diagrams illustrating the display of a pixel with an image display system according to one embodiment of the present invention.

FIG. 5 is a diagram illustrating the generation of low resolution sub-frames from an original high resolution image using a nearest neighbor algorithm according to one embodiment of the present invention.

FIG. 6 is a diagram illustrating the generation of low resolution sub-frames from an original high resolution image using a bilinear algorithm according to one embodiment of the present invention.

FIG. 7A is a block diagram illustrating components of the image display system shown in FIG. 1 according to one embodiment of the present invention.

FIG. 7B is a block diagram illustrating components of the image display system shown in FIG. 1 according to another embodiment of the present invention.

FIG. 8 is a flow diagram illustrating a method for generating and displaying sub-frames according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

### I. Spatial and Temporal Shifting of Sub-Frames

Some display systems, such as some digital light projectors, may not have sufficient resolution to display some high resolution images. Such systems can be configured to give the appearance to the human eye of higher resolution images by displaying spatially and temporally shifted lower resolution images. These systems are also capable of delivering information at higher spatial frequencies than conventional display systems that do not display spatially and temporally shifted images. Spatially organized image data is an image frame. Data collections for the lower resolution images are referred to as sub-frames. A problem of sub-frame generation, which is addressed by embodiments of the present invention, is to determine appropriate data values for the sub-frames so that the displayed sub-frames are close in appearance to how the high-resolution image from which the sub-frames were derived would ideally appear if displayed.

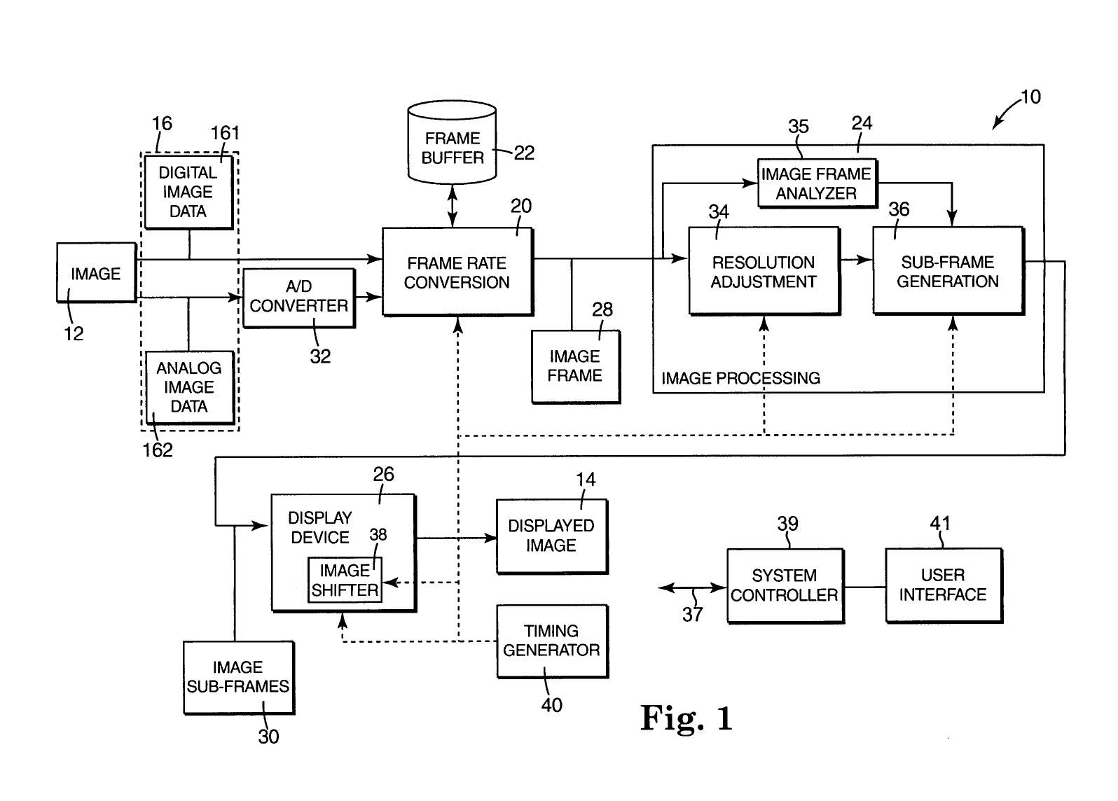

One embodiment of a display system that provides the appearance of enhanced resolution through temporal and spatial shifting of sub-frames is described in the U.S. patent applications cited above, and is summarized below with reference to FIGS. 1-4E.

FIG. 1 is a block diagram illustrating an image display system 10 according to one embodiment of the present invention. Image display system 10 facilitates processing of an image 12 to create a displayed image 14. Image 12 is defined to include any pictorial, graphical, and/or textural characters, symbols, illustrations, and/or other representation of information. Image 12 is represented, for example, by image data 16. Image data 16 includes individual picture elements or pixels of image 12. While one image is illustrated and described as being processed by image display system 10, it is understood that a plurality or series of images may be processed and displayed by image display system 10.

In one embodiment, image display system 10 includes a frame rate conversion unit 20 and an image frame buffer 22, an image processing unit 24, and a display device 26. As described below, frame rate conversion unit 20 and image frame buffer 22 receive and buffer image data 16 for image 12 to create an image frame 28 for image 12. Image processing unit 24 processes image frame 28 to define one or more image sub-frames 30 for image frame 28, and display device 26 temporally and spatially displays image sub-frames 30 to produce displayed image 14.

Image display system 10, including frame rate conversion unit 20 and/or image processing unit 24, includes hardware, software, firmware, or a combination of these. In one embodiment, one or more components of image display system 10, including frame rate conversion unit 20 and/or image processing unit 24, are included in a computer, computer server, or other microprocessor-based system capable of performing a sequence of logic operations. In addition, processing can be distributed throughout the system with individual portions being implemented in separate system components.

Image data 16 may include digital image data 161 or analog image data 162. To process analog image data 162, image display system 10 includes an analog-to-digital (A/D) converter 32. As such, A/D converter 32 converts analog image data 162 to digital form for subsequent processing. Thus, image display system 10 may receive and process digital image data 161 and/or analog image data 162 for image 12.

Frame rate conversion unit 20 receives image data 16 for image 12 and buffers or stores image data 16 in image frame buffer 22. More specifically, frame rate conversion unit 20 receives image data 16 representing individual lines or fields of image 12 and buffers image data 16 in image frame buffer 22 to create image frame 28 for image 12. Image frame buffer 22 buffers image data 16 by receiving and storing all of the image data for image frame 28, and frame rate conversion unit 20 creates image frame 28 by subsequently retrieving or extracting all of the image data for image frame 28 from image frame buffer 22. As such, image frame 28 is defined to include a plurality of individual lines or fields of image data 16 representing an entirety of image 12. In one embodiment, image frame 28 includes a plurality of columns and a plurality of rows of individual pixels representing image 12. In other embodiments, other types of organizations may be used for image frame 28, including, for example, a diamond pixel pattern.

Frame rate conversion unit 20 and image frame buffer 22 can receive and process image data 16 as progressive image data and/or interlaced image data. With progressive image data, frame rate conversion unit 20 and image frame buffer 22 receive and store sequential field lines of image data 16 for image 12. Thus, frame rate conversion unit 20 creates image frame 28 by retrieving the sequential field lines of image data 16 for image 12. With interlaced image data, frame rate conversion unit 20 and image frame buffer 22 receive and store odd fields and even fields of image data 16 for images 12. For example, all of the odd field lines of image data 16 are received and stored and all of the even field lines of image data 16 are received and stored. As such, frame rate conversion unit 20 de-interlaces image data 16 and creates image frame 28 by retrieving the odd and even fields of image data 16 for image 12.

Image frame buffer 22 includes memory for storing image data 16 for one or more image frames 28 of respective images 12. Thus, image frame buffer 22 constitutes a database of one or more image frames 28. Examples of image frame buffer 22 include non-volatile memory (e.g., a hard disk drive or other persistent storage device) and may include volatile memory (e.g., random access memory (RAM)).

By receiving image data 16 at frame rate conversion unit 20 and buffering image data 16 with image frame buffer 22, input timing of image data 16 can be decoupled from a timing requirement of display device 26. More specifically, since image data 16 for image frame 28 is received and stored by image frame buffer 22, image data 16 can be received as input at any rate. As such, the frame rate of image frame 28 can be converted to the timing requirement of display device 26. Thus, image data 16 for image frame 28 can be extracted from image frame buffer 22 at a frame rate of display device 26.

In one embodiment, image processing unit 24 includes a resolution adjustment unit 34, an image frame analyzer 35, and a sub-frame generation unit 36. As described below, resolution adjustment unit 34 receives image data 16 for image frame 28 and adjusts a resolution of image data 16 for display on display device 26, and sub-frame generation unit 36 generates a plurality of image sub-frames 30 for image frame 28. More specifically, image processing unit 24 receives image data 16 for image frame 28 at an original resolution and processes image data 16 to increase, decrease, and/or leave unaltered the resolution of image data 16. Accordingly, with image processing unit 24, image display system 10 can receive and display image data 16 of varying resolutions. Image frame analyzer 35 analyzes received image frames 28 and generates corresponding image frame analysis data, as described in further detail below.

Sub-frame generation unit 36 receives and processes image data 16 for image frame 28 to define a plurality of image sub-frames 30 for image frame 28. If resolution adjustment unit 34 has adjusted the resolution of image data 16, sub-frame generation unit 36 receives image data 16 at the adjusted resolution. The adjusted resolution of image data 16 may be increased, decreased, or the same as the original resolution of image data 16 for image frame 28. Sub-frame generation unit 36 generates image sub-frames 30 with a resolution which matches a resolution of display device 26. In one embodiment, sub-frames 30 each include a plurality of columns and a plurality of rows of individual pixels representing a subset of image data 16 of image 12, and have a resolution that matches the resolution of display device 26.

Each image sub-frame 30 includes a matrix or array of pixels for image frame 28. Image sub-frames 30 are spatially offset from each other such that each image sub-frame 30 includes different pixels and/or portions of pixels from its parent frame 28. In one embodiment, image sub-frames 30 are offset from each other by a vertical distance and/or a horizontal distance, as described below.

Display device 26 receives image sub-frames 30 from image processing unit 24 and sequentially displays image sub-frames 30 to create displayed image 14. More specifically, as image sub-frames 30 are spatially offset from each other, display device 26 displays image sub-frames 30 in different positions according to the spatial offset of image sub-frames 30, as described below. As such, display device 26 alternates between displaying image sub-frames 30 for image frame 28 to create displayed image 14. Accordingly, display device 26 may display an entire sub-frame 30 for image frame 28 at one time.

In one embodiment, display device 26 performs one cycle of displaying image sub-frames 30 for each image frame 28. Display device 26 displays image sub-frames 30 so as to be spatially and temporally offset from each other. In one embodiment, display device 26 optically steers image sub-frames 30 to create displayed image 14. As such, individual pixels of display device 26 are addressed to multiple locations in displayed image 14.

In one embodiment, display device 26 includes an image shifter 38. Image shifter 38 spatially alters or offsets the displayed position of image sub-frames 30 as displayed by display device 26. More specifically, image shifter 38 varies the position of display of image sub-frames 30, as described below, to produce displayed image 14.

In one embodiment, display device 26 includes a light modulator for modulation of incident light. The light modulator includes, for example, a plurality of micro-mirror devices arranged to form an array of micro-mirror devices. As such, each micro-mirror device constitutes one cell or pixel of display device 26. Display device 26 may form part of a display, projector, or other imaging system.

In one embodiment, image display system 10 includes a timing generator 40. Timing generator 40 communicates, for example, with frame rate conversion unit 20, image processing unit 24, including resolution adjustment unit 34 and sub-frame generation unit 36, and display device 26, including image shifter 38. As such, timing generator 40 synchronizes buffering and conversion of image data 16 to create image frame 28, processing of image frame 28 to adjust the resolution of image data 16 and generate image sub-frames 30, and positioning and displaying of image sub-frames 30 to produce displayed image 14. Accordingly, timing generator 40 controls timing of image display system 10 such that entire images of sub-frames 30 of image 12 are temporally and spatially displayed by display device 26 as displayed image 14.

In one embodiment, image display system 10 also includes a system controller 39 and a user interface device 41. In one embodiment, user interface device 41 is an interactive menu with an input/selection device such as a mouse, keyboard, or other device that allows a user to enter information into and interact with display system 10. In one form of the invention, system controller 39 is coupled to the various components (e.g., A/D converter 32, frame rate conversion unit 20, frame buffer 22, image processing unit 24, display device 26, image shifter 38, and timing generator 40) of system 10 via communication link 37. To simplify the illustration, the individual connections between controller 39 and the various components of system 10 are not shown in FIG. 1, but rather are represented generally by communication link 37. In one embodiment, controller 39 receives status information from the components of system 10, and outputs control information to the components of system 10, via communication link 37.

It will be understood by persons of ordinary skill in the art that, in an actual implementation, some of the blocks shown in FIG. 1 may be combined. As one example, the resolution adjustment and sub-frame generation may be performed in a single processing operation.

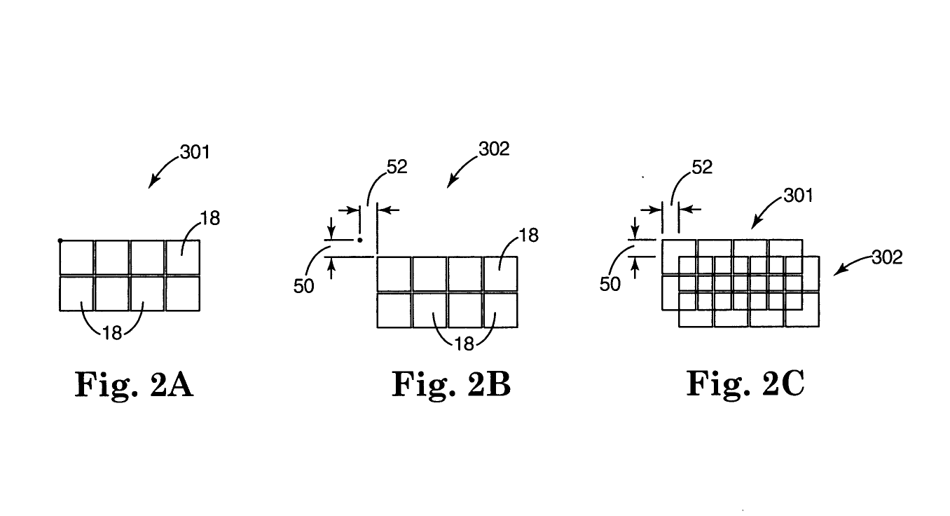

In one embodiment, as illustrated in FIGS. 2A and 2B, image processing unit 24 defines two image sub-frames 30, to be displayed for image frame 28. More specifically, image processing unit 24 defines a first sub-frame for image frame 28, which is displayed by display device 26 as sub-frame image 301, and image processing unit 24 defines a second sub-frame for image frame 28, which is displayed by display device 26 as sub-frame image 302. As such, first sub-frame image 301 and second sub-frame image 302 each include a plurality of columns and a plurality of rows of individual pixels 18 of image data 16. Thus, in one embodiment, first sub-frame image 301 and second sub-frame image 302 each constitute an image from a data array or pixel matrix of a subset of image data 16.

In one embodiment, as illustrated in FIG. 2B, second sub-frame image 302 is offset from first sub-frame image 301 by a vertical distance 50 and a horizontal distance 52. As such, second sub-frame image 302 is spatially offset from first sub-frame image 301 by a predetermined distance. In one illustrative embodiment, vertical distance 50 and horizontal distance 52 are each approximately one-half of one display device pixel.

As illustrated in FIG. 2C, display device 26 alternates between displaying first sub-frame image 301 in a first position and displaying second sub-frame image 302 in a second position spatially offset from the first position. More specifically, display device 26 shifts display of second sub-frame image 302 relative to display of first sub-frame image 301 by vertical distance 50 and horizontal distance 52. As such, pixels of first sub-frame image 301 overlap pixels of second sub-frame image 302. In one embodiment, display device 26 performs one cycle of displaying first sub-frame image 301 in the first position and displaying second sub-frame image 302 in the second position for image frame 28. Thus, second sub-frame image 302 is spatially and temporally displaced relative to first sub-frame image 301. The display of two temporally and spatially shifted sub-frames in this manner is referred to herein as two-position processing. In other embodiments, sub-frame images 301 and 302 are spatially displaced using other vertical and/or horizontal distances (e.g., using only vertical displacements or only horizontal displacements).

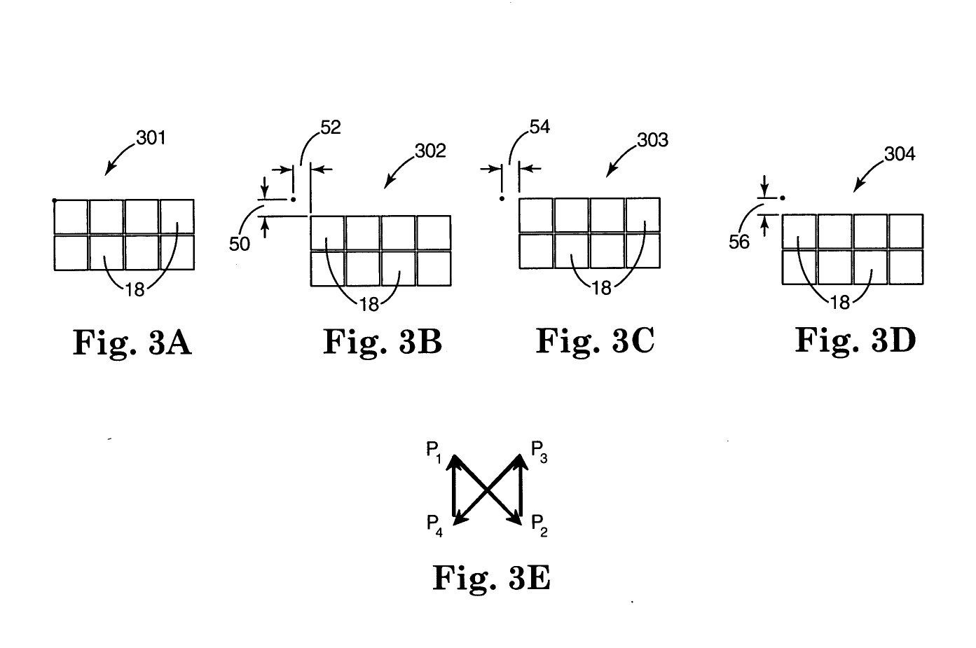

In another embodiment, as illustrated in FIGS. 3A-3D, image processing unit 24 defines four image sub-frames 30 for image frame 28. More specifically, image processing unit 24 defines a first sub-frame for display as sub-frame image 301, a second sub-frame displayed as sub-frame image 302, a third sub-frame displayed as sub-frame image 303, and a fourth sub-frame displayed as sub-frame image 304 for image frame 28. In one embodiment, the sub-frames 30 for first sub-frame image 301, second sub-frame image 302, third sub-frame image 303, and fourth sub-frame image 304 each include a plurality of columns and a plurality of rows of individual pixels 18 of image data 16.

In one embodiment, as illustrated in FIGS. 3B-3D, second sub-frame image 302 is offset from first sub-frame image 301 by a vertical distance 50 and a horizontal distance 52, third sub-frame image 303 is offset from first sub-frame image 301 by a horizontal distance 54, and fourth sub-frame image 304 is offset from first sub-frame image 301 by a vertical distance 56. As such, second sub-frame image 302, third sub-frame image 303, and fourth sub-frame image 304 are each spatially offset from each other and spatially offset from first sub-frame image 301 by a predetermined distance. In one illustrative embodiment, vertical distance 50, horizontal distance 52, horizontal distance 54, and vertical distance 56 are each approximately one-half of one pixel.

As illustrated schematically in FIG. 3E, display device 26 alternates between displaying first sub-frame image 301 in a first position P₁, displaying second sub-frame image 302 in a second position P₂ spatially offset from the first position, displaying third sub-frame image 303 in a third position P₃ spatially offset from the first position, and displaying fourth sub-frame image 304 in a fourth position P₄ spatially offset from the first position. More specifically, display device 26 shifts display of second sub-frame image 302, third sub-frame image 303, and fourth sub-frame image 304 relative to first sub-frame image 301 by the respective predetermined distance. As such, pixels of first sub-frame image 301, second sub-frame image 302, third sub-frame image 303, and fourth sub-frame image 304 overlap each other in displayed image 14.

In one embodiment, display device 26 performs one cycle of displaying first sub-frame image 301 in the first position, displaying second sub-frame image 302 in the second position, displaying third sub-frame image 303 in the third position, and displaying fourth sub-frame image 304 in the fourth position for image frame 28. Thus, second sub-frame image 302, third sub-frame image 303, and fourth sub-frame image 304 are spatially and temporally displayed relative to each other and relative to first sub-frame image 301. The display of four temporally and spatially shifted sub-frames in this manner is referred to herein as four-position processing.

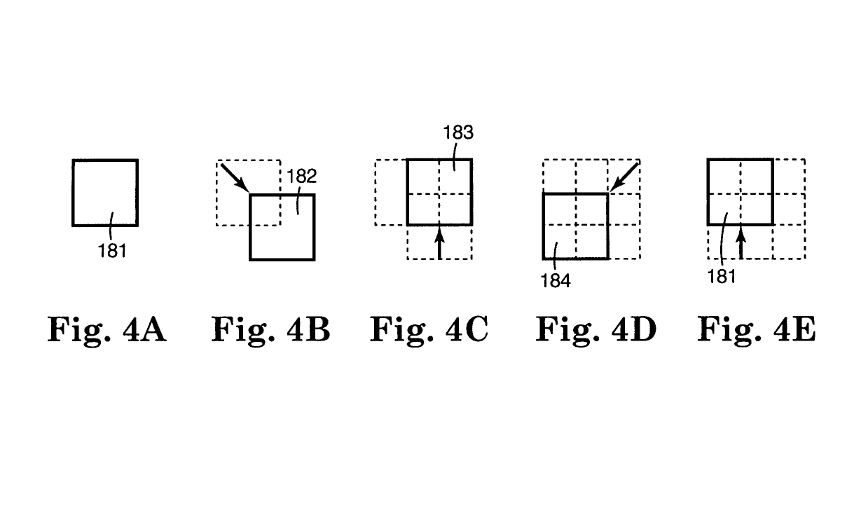

FIGS. 4A-4E illustrate one embodiment of completing one cycle of displaying a pixel 181 from first sub-frame image 301 in the first position, displaying a pixel 182 from second sub-frame image 302 in the second position, displaying a pixel 183 from third sub-frame image 303 in the third position, and displaying a pixel 184 from fourth sub-frame image 304 in the fourth position. More specifically, FIG. 4A illustrates display of pixel 181 from first sub-frame image 301 in the first position, FIG. 4B illustrates display of pixel 182 from second sub-frame image 302 in the second position (with the first position being illustrated by dashed lines), FIG. 4C illustrates display of pixel 183 from third sub-frame image 303 in the third position (with the first position and the second position being illustrated by dashed lines), FIG. 4D illustrates display of pixel 184 from fourth sub-frame image 304 in the fourth position (with the first position, the second position, and the third position being illustrated by dashed lines), and FIG. 4E illustrates display of pixel 181 from first sub-frame image 301 in the first position (with the second position, the third position, and the fourth position being illustrated by dashed lines).

Sub-frame generation unit 36 (FIG. 1) generates sub-frames 30 based on image data in image frame 28. It will be understood by a person of ordinary skill in the art that functions performed by sub-frame generation unit 36 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

In one form of the invention, sub-frames 30 have a lower resolution than image frame 28. Thus, sub-frames 30 are also referred to herein as low resolution image sub-frames 30, and image frame 28 is also referred to herein as a high resolution image frame 28. It will be understood by persons of ordinary skill in the art that the terms low resolution and high resolution are used herein in a comparative fashion, and are not limited to any particular minimum or maximum number of pixels.

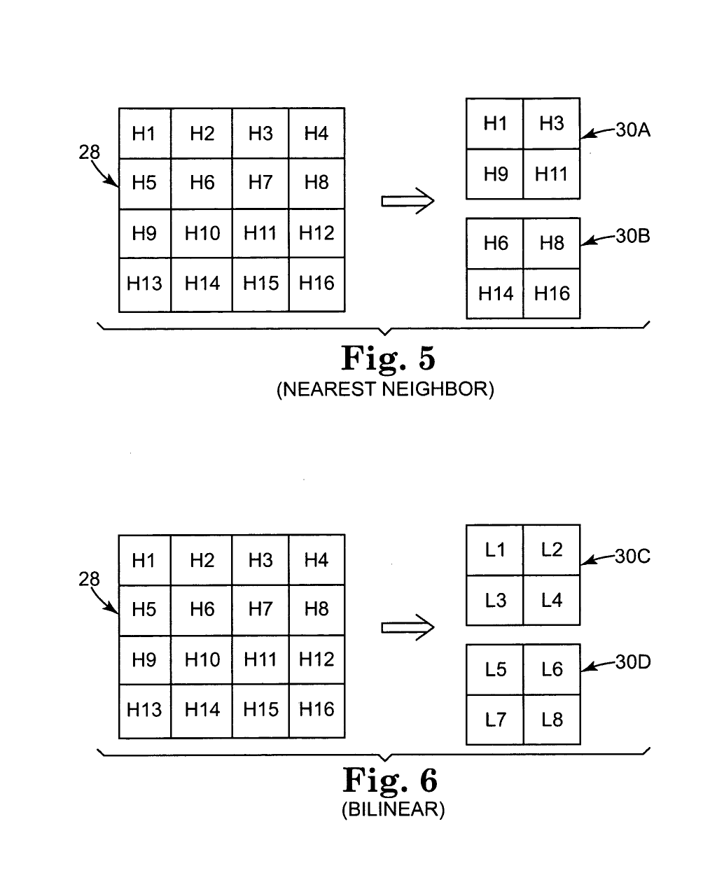

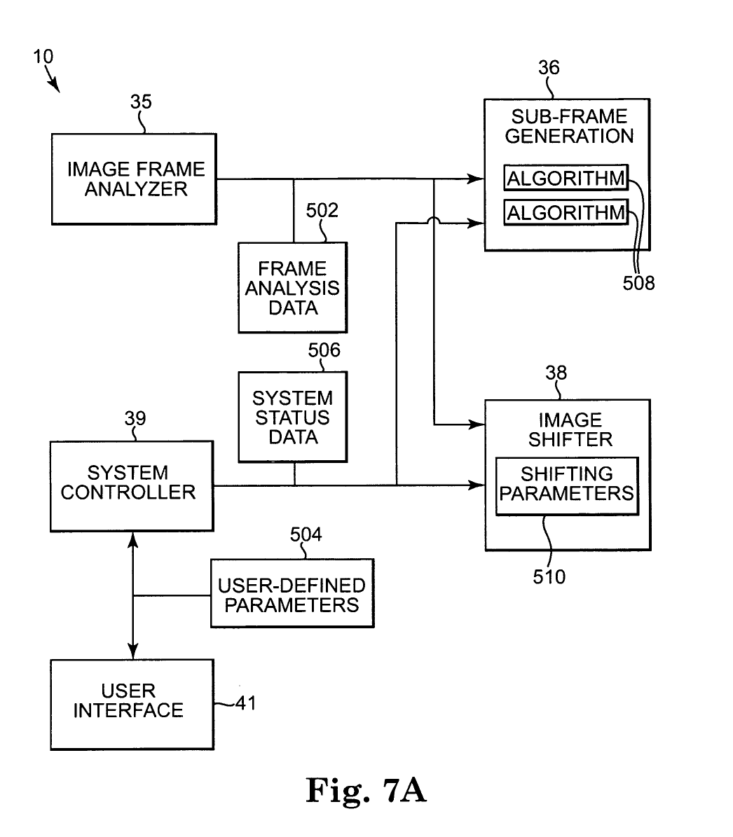

Sub-frame generation unit 36 is configured to use one or more sub-frame generation algorithms to calculate pixel values for sub-frames 30. In one embodiment, sub-frame generation unit 36 is configured to generate pixel values for sub-frames 30 based on a nearest neighbor algorithm or a bilinear algorithm. The nearest neighbor algorithm and the bilinear algorithm according to one form of the invention generate pixel values for sub-frames 30 by selecting and/or combining pixels from a high resolution image frame 28, as described in further detail below with reference to FIGS. 5 and 6. In another embodiment, the pixel values for sub-frames 30 are generated based on another type of algorithm, such as an algorithm that generates pixel values based on the minimization of an error metric that represents a difference between a simulated high resolution image and a desired high resolution image frame 28. In yet another embodiment, boundary pixel values for sub-frames 30 are generated for two-position or four-position processing, and then these boundary pixel values are used to generate actual pixel values (e.g., based on a weighted sum of the boundary pixel values) for any desired sub-frame motion, including triangular motion, circular motion, or any other desired motion or pattern. Such algorithms are described in the U.S. patent applications cited above, which are incorporated by reference.

### II. Nearest Neighbor

FIG. 5 is a diagram illustrating the generation of low resolution sub-frames 30A and 30B (collectively referred to as sub-frames 30) from an original high resolution image frame 28 using a nearest neighbor algorithm according to one embodiment of the present invention. In the illustrated embodiment, high resolution image 28 includes four columns and four rows of pixels, for a total of sixteen pixels H1-H16. In one embodiment of the nearest neighbor algorithm, a first sub-frame 30A is generated by taking every other pixel in a first row of the high resolution image frame 28, skipping the second row of the high resolution image frame 28, taking every other pixel in the third row of the high resolution image frame 28, and repeating this process throughout the high resolution image frame 28. Thus, as shown in FIG. 5, the first row of sub-frame 30A includes pixels H1 and H3, and the second row of sub-frame 30A includes pixels H9 and H11. In one form of the invention, a second sub-frame 30B is generated in the same manner as the first sub-frame 30A, but the process is offset and begins at a pixel H6 that is shifted down one row and over one column from the first pixel H1. Thus, as shown in FIG. 5, the first row of sub-frame 30B includes pixels H6 and H8, and the second row of sub-frame 30B includes pixels H14 and H16.

The nearest neighbor algorithm is also applicable to four-position processing, and is not limited to images having the number or arrangement of pixels shown in FIG. 5.

### III. Bilinear

FIG. 6 is a diagram illustrating the generation of low resolution sub-frames 30C and 30D (collectively referred to as sub-frames 30) from an original high resolution image frame 28 using a bilinear algorithm according to one embodiment of the present invention. In the illustrated embodiment, high resolution image frame 28 includes four columns and four rows of pixels, for a total of sixteen pixels H1-H16. Sub-frame 30C includes two columns and two rows of pixels, for a total of four pixels L1-L4. And sub-frame 30D includes two columns and two rows of pixels, for a total of four pixels L5-L8.

In one embodiment, the values for pixels L1-L8 in sub-frames 30C and 30D are generated from the pixel values H1-H16 of image frame 28 based on the following Equations I-VIII:

L1=(6H1+H2+H5)/8 Equation I

L2=(5H3+H4+H7+H2)/8 Equation II

L3=(6H9+H10+H13)/8 Equation III

L4=(4H11+H7+H12+H15+H10)/8 Equation IV

L5=(4H6+H2+H7+H10+H5)/8 Equation V

L6=(5H8+H4+H12+H7)/8 Equation VI

L7=(5H14+H10+H15+H13)/8 Equation VII

L8=(6H16+H12+H15)/8 Equation VIII

As can be seen from the above Equations I-VIII, the values of the pixels L1-L4 in sub-frame 30C are influenced the most by the values of pixels H1, H3, H9, and H11, respectively, due to the multiplication by four, five, or six. But the values for the pixels L1-L4 in sub-frame 30C are also influenced by the values of north, south, east, and west neighbors of pixels H1, H3, H9, and H11. Similarly, the values of the pixels L5-L8 in sub-frame 30D are influenced the most by the values of pixels H6, H8, H14, and H16, respectively, due to the multiplication by four, five, or six. But the values for the pixels L5-L8 in sub-frame 30D are also influenced by the values of north, south, east, and west neighbors of pixels H6, H8, H14, and H16.

In one embodiment, the bilinear algorithm is implemented with a 3×3 filter with corner filter coefficients of “0”, north/south and east/west neighbor coefficients of “1”, and a center coefficient of “4”, to generate a weighted sum of the pixel values from the high resolution image frame. In another embodiment, other values are used for the filter coefficients. The bilinear algorithm is also applicable to four-position processing, and is not limited to images having the number or arrangement of pixels shown in FIG. 6.

In one form of the nearest neighbor and bilinear algorithms, pixel values for sub-frames 30 are generated based on a linear combination of pixel values from an original high resolution image frame 28 as described above. In another embodiment, pixel values for sub-frames 30 are generated based on a non-linear combination of pixel values from an original high resolution image frame 28. For example, if the original high resolution image frame 28 is gamma-corrected, appropriate non-linear combinations are used in one embodiment to undo the effect of the gamma curve.

### IV. Adaptive Display System

Existing display systems that produce spatially-shifted images use a single sub-frame generation algorithm and typically use a fixed shifting pattern during the display of the images. These existing systems do not adapt to changing conditions and do not take into account user preferences. One form of the present invention is an adaptive display system 10 that is configured to continually and automatically update or modify the sub-frame generation process and sub-frame shifting parameters based on one or more of the following parameters: (1) characteristics of the image frames 28; (2) characteristics and status of the display system 10; (3) user-defined parameters; and (4) other parameters.

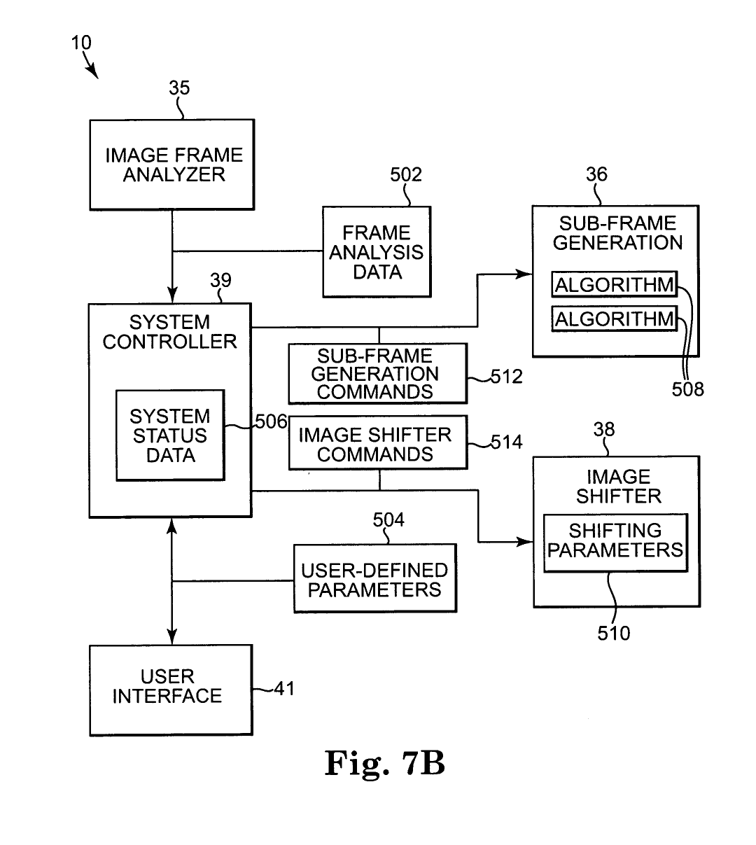

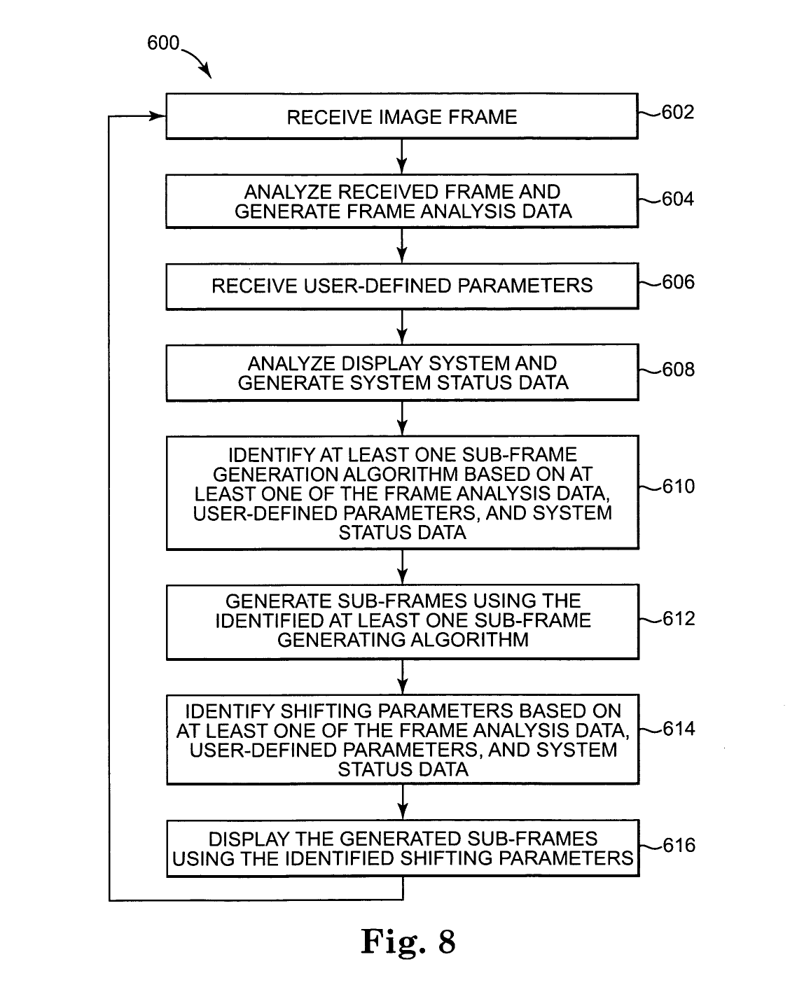

One form of the present invention improves the quality of the displayed images 14 by modifying or adapting the sub-frames 30 and shifting of the sub-frames 30 based on image content of current and previous image frames 28, as well as other parameters. By incorporating these parameters in the generation of the sub-frames 30, and the shifting of the sub-frames 30 during display, artifact suppression is improved, dark scene noise is reduced, perceived image quality is improved, and the system 10 optimizes the display for an improved user experience. The adaptive display system 10 according to one embodiment of the invention is described in further detail below with reference to FIGS. 7 and 8.

FIG. 7A is a block diagram illustrating components of the image display system 10 shown in FIG. 1 according to one embodiment of the present invention. Image frame analyzer 35 receives image frames 28, generates corresponding image frame analysis data 502, and outputs the frame analysis data 502 to sub-frame generation unit 36 and image shifter 38. In one embodiment, the frame analysis data 502 includes resolution information, spatially varying detail information (e.g., amount of detail at various regions of the image frames 28, such as the amount of detail at the edges of images frames 28 versus the amount of detail in the interior regions of the image frames 28), brightness information, and information representing an amount of motion in the frames 28. In other embodiments, additional information may be included in the frame analysis data 502.

System controller 39 generates system status data 506, and outputs the system status data 506 to sub-frame generation unit 36 and image shifter 38. In one embodiment, the system status data 506 includes defective pixel information (e.g., information identifying any pixels of display device 26 that are stuck on, stuck off, or otherwise not functioning properly), distortion information (e.g., information that identifies any distortions produced by the optics of display device 26, which may cause a non-uniform displacement across a given sub-frame 30), drift information (e.g., information that identifies any deviations between the desired or expected display positions of sub-frames 30 and the actual display positions of sub-frames 30), pixel shape information (e.g., information that identifies the shape of pixels of display device 26, such as square, rectangular, or diamond), and display conditions (e.g., ambient light, screen brightness, image size, as well as other display conditions). Display conditions are described in U.S. Pat. No. 7,019,736, entitled METHOD AND APPARATUS FOR IMAGE DISPLAY, which is incorporated by reference. In other embodiments, additional information may be included in the system status data 506. In one form of the invention, some or all of the information that is included in system status data 506 is automatically detected by components of display system 10. In another form of the invention, some or all of the information that is included in system status data 506 is manually entered into system controller 39 by a user, or entered during manufacture.

A user enters user-defined parameters 504 into system controller 39 via user interface device 41. System controller 39 then outputs the user-defined parameters 504 to sub-frame generation unit 36 and image shifter 38. In one embodiment, the user-defined parameters 504 include sharpness information representing a user's desired sharpness of displayed images 14 (e.g., a desired image quality attribute ranging from sharp to smooth). In other embodiments, additional information may be included in the user-defined parameters 504, such as a desired quantity of sub-frame display positions for each image frame 28, and a desired number of pixels in the displayed image 14.

Sub-frame generation unit 36 includes a plurality of different sub-frame generation algorithms 508. In one embodiment, the sub-frame generation algorithms 508 include a nearest neighbor algorithm (FIG. 5); a bilinear algorithm (FIG. 6); an algorithm that generates pixel values based on the minimization of an error metric that represents a difference between a simulated high resolution image and a desired high resolution image frame 28; an algorithm that generates boundary pixel values for sub-frames 30 for two-position or four-position processing, and then uses the boundary pixel values to generate actual pixel values (e.g., based on a weighted sum of the boundary pixel values) for any desired sub-frame motion; as well as other sub-frame generation algorithms.

In one embodiment, sub-frame generation unit 36 is configured to identify one or more of the sub-frame generation algorithms 508 to use for each image frame 28 (or for a set of image frames 28) based on one or more of the frame analysis data 502, user-defined parameters 504, and system status data 506.

Image shifter 38 includes sub-frame shifting parameters 510. In one form of the invention, image shifter 38 is configured to cause the sub-frames 30 to be spatially shifted when displayed based on the shifting parameters 510. In one embodiment, shifting parameters 510 include number or quantity of positions information (e.g., the number of sub-frame display positions used by image shifter 38 for each image frame 28), display location information (e.g., the X and Y locations of the sub-frame display positions), displacement pattern information (e.g., the pattern that image shifter 38 follows when shifting through the various sub-frame display positions, such as rectangle, square, parallelogram, triangle, circle, etc.), displacement speed information (e.g., the speed at which the image shifter 38 moves from one sub-frame display position to another sub-frame display position), duration of sub-frame display information (e.g., the amount of time that each sub-frame 30 is displayed), and number or quantity of sub-frames 30 to generate for a given image frame 28.

In one embodiment, image shifter 38 is configured to determine appropriate shifting parameters 510 to use for each image frame 28 (or for a set of image frames 28) based on one or more of the frame analysis data 502, user-defined parameters 504, and system status data 506.

In another form of the invention, image frame analyzer 35 is configured to output frame analysis data 502 to system controller 39, which is configured to identify one or more of the sub-frame generation algorithms 508 and determine appropriate shifting parameters 510 to use for each image frame 28 (or for a set of image frames 28) based on one or more of the frame analysis data 502, user-defined parameters 504, and system status data 506. In this embodiment, system controller 39 sends commands to sub-frame generation unit 36 and image shifter 38, which cause the identified sub-frame generation algorithms 508 and shifting parameters 510 to be executed by the sub-frame generation unit 36 and image shifter 38.

A few examples of the modification of the sub-frame generation process and sub-frame shifting parameters according to specific embodiments of the present invention will now be described. As a first example, if image frame analyzer 35 determines that a given image frame 28 includes a relatively large amount of detail (e.g., significant energy at high spatial frequencies) in a first region of the frame 28, and the frame 28 has a second region that is relatively dark with a relatively small amount of detail (e.g., most energy confined to lower spatial frequencies), image frame analyzer 35 includes information representing this situation in image frame analysis data 502. In one embodiment, when sub-frame generation unit 36 receives this image frame analysis data 502, sub-frame generation unit 36 selects a first sub-frame generation algorithm 508 for the first region of the frame 28, and a second sub-frame generation algorithm 508 for the second region of the frame 28. The first sub-frame generation algorithm 508 may be a more complex and accurate algorithm that better represents higher detail regions, and the second sub-frame generation algorithm 508 may be a simpler algorithm that helps reduce dark scene noise.

As a second example, if image frame analyzer 35 determines that the resolution of a given image frame 28 is relatively low (e.g., close to the native resolution of display device 26), image frame analyzer 35 includes information representing this situation in image frame analysis data 502. In one embodiment, when image shifter 38 receives this image frame analysis data 502, image shifter 38 changes the shifting parameters 510 to provide no shifting or a relatively small amount of shifting (e.g., two-position processing) during the display of sub-frames 30. In contrast, if the image frame analysis data 502 indicates that the resolution of the image frame 28 is relatively high compared to the native resolution of the display device 26, image shifter 38 changes the shifting parameters 510 to provide a relatively large amount of shifting (e.g., four-position processing) during the display of sub-frames 30.

As a third example, if a user enters user-defined parameters 504 that indicate that the user prefers a softer appearance for displayed images 14, when image shifter 38 receives these user-defined parameters 504, image shifter 38 changes the shifting parameters 510 to provide a slower transition between sub-frame display positions (e.g., near sine wave motion), which causes the displayed sub-frames 30 to be smeared slightly and produce a softer appearance of the displayed image 14. In contrast, if a user enters user-defined parameters 504 that indicate that the user prefers a sharper appearance for displayed images 14, when image shifter 38 receives these user-defined parameters 504, image shifter 38 changes the shifting parameters 510 to provide a faster transition between sub-frame display positions with longer dwell at each display position (e.g., near square wave motion), which will produce a sharper appearance of the displayed image 14. In another embodiment, in addition to modifying the speed of the transitions, or as an alternative to such a modification, image shifter 38 increases (for a sharper appearance) or decreases (for a softer appearance) the number of sub-frame display positions for a given image frame 28, and/or modifies the pattern of movement between sub-frame display positions, to change the degree of sharpness.

One reason to go to a particular number of sub-frame display positions is to give the display a particular native pixel addressing resolution. If the display resolution for a given number and sequence of positions matches the input data resolution, for example, it may be good to display sub-frames 30 using that number and sequence of positions. In some cases, this may result in some pixels of display device 26 not being used. This commonly occurs, for example, when a 4:3 image is reproduced on a 16:9 display without scaling, unused pixels flank both sides of a 4:3 region of active pixels on the larger 16:9 display surface. Matching display resolution to input data resolution can be especially valuable for images with single-pixel features such as text and fine lines. If the image content is predominately photographic type images (including video), it is often desirable to hide pixel screen door artifacts, and going to multiple sub-frame display positions can hide such artifacts. Finally, changing the positioning “profile” of the image shifter 38 can affect image quality and also how much noise the system produces.

As a fourth example, if image frame analyzer 35 determines that a given image frame 28 includes a relatively large amount of detail (e.g., significant energy at high spatial frequencies), image frame analyzer 35 includes information representing this situation in image frame analysis data 502. In one embodiment, when image shifter 38 receives this image frame analysis data 502, image shifter 38 changes the shifting parameters 510 to provide a faster transition between sub-frame display positions with longer dwell at each display position (e.g., near square wave motion), which will produce a sharper appearance of the displayed image 14, and better represent the relatively large amount of detail. In contrast, if the image frame analysis data 502 indicates that the image frame 28 includes a relatively small amount of detail (e.g., low spatial frequency), image shifter 38 changes the shifting parameters 510 to provide a slower transition between sub-frame display positions (e.g., near sine wave motion), which will produce a softer appearance of the displayed image 14 with reduced visibility of individual pixels.

As a fifth example, if image frame analyzer 35 determines that a given set of image frames 28 includes a relatively large amount of motion, such as a car chase scene in a movie, image frame analyzer 35 includes information representing this situation in image frame analysis data 502. In one embodiment, when sub-frame generation unit 36 receives this image frame analysis data 502, sub-frame generation unit 36 selects a first sub-frame generation algorithm 508 that is appropriate for image frames 28 that contain a relatively large amount of motion. In contrast, if the image frame analysis data 502 indicates that the set of image frames 28 includes a relatively small amount of motion, sub-frame generation unit 36 selects a second sub-frame generation algorithm 508 that is appropriate for image frames 28 that contain a relatively small amount of motion.

As a sixth example, if the system status data 506 indicates that display device 26 includes defective pixels, the optics of display device 26 are producing distortion in displayed images of image sub-frames 30, and/or the actual sub-frame display positions are deviating or drifting from the desired sub-frame display positions, when sub-frame generation unit 36 receives this system status data 506, sub-frame generation unit 36 selects one or more sub-frame generation algorithms 508 and applies these algorithms 508 in a manner that helps compensate for the defective pixels, distortion, and/or drift. Similarly, image shifter 38 will also change the shifting parameters 510 in response to this system status data 506 to help compensate for the defective pixels, distortion, and/or drift. Compensation of defective pixels is described in U.S. Pat. No. 7,034,811, entitled IMAGE DISPLAY SYSTEM AND METHOD, which is incorporated by reference.

It will be understood by persons of ordinary skill in the art that the above examples are just a few of the possible implementations, and that the scope of the present application is not limited to the examples set forth herein. Rather, this application is intended to cover any adaptations or variations of the preferred embodiments discussed herein.

FIG. 7B is a block diagram illustrating components of the image display system 10 shown in FIG. 1 according to another embodiment of the present invention. In the embodiment shown in FIG. 7B, image frame analyzer 35 is configured to output frame analysis data 502 to system controller 39, which is configured to identify one or more of the sub-frame generation algorithms 508 and determine appropriate shifting parameters 510 to use for each image frame 28 (or for a set of image frames 28) based on one or more of the frame analysis data 502, user-defined parameters 504, and system status data 506. In this embodiment, system controller 39 sends sub-frame generation commands 512 to sub-frame generation unit 36, and image shifter commands 514 to image shifter 38, which cause the identified sub-frame generation algorithms 508 and shifting parameters 510 to be executed by the sub-frame generation unit 36 and image shifter 38.

FIG. 8 is a flow diagram illustrating a method 600 for generating and displaying sub-frames 30 according to one embodiment of the present invention. In one embodiment, display system 10 is configured to perform method 600. At 602, image processing unit 24 (FIG. 1) receives a high-resolution image frame 28. At 604, image frame analyzer 35 analyzes the received image frame 28, generates corresponding image frame analysis data 502, and outputs the frame analysis data 502 to system controller 39. In another embodiment, in addition to analyzing the received image frame 28, image frame analyzer 35 also analyzes previously received image frames 28, and includes information from that analysis in image frame analysis data 502.

At 606, system controller 39 receives user-defined parameters 504, which are entered by a user via user interface 41. At 608, system controller 39 analyzes the display system 10, and generates corresponding system status data 506.

At 610, system controller 39 identifies at least one of the sub-frame generation algorithms 508 to use for the received image frame 28 based on at least one of the frame analysis data 502 (received at 604), user-defined parameters 504 (received at 606), and system status data 506 (generated at 608), and sends corresponding sub-frame generation commands 512 to sub-frame generation unit 36. At 612, sub-frame generation unit 36 generates at least one sub-frame 30 corresponding to the received image frame 28 using the at least one sub-frame generation algorithm 508 identified at 610.

At 614, system controller 39 identifies appropriate shifting parameters 510 to use for the received image frame 28 based on at least one of the frame analysis data 502 (received at 604), user-defined parameters 504 (received at 606), and system status data 506 (generated at 608), and sends corresponding image shifter commands 514 to image shifter 38. At 616, display device 26 displays the generated sub-frames 30 (generated at 612) at spatially offset sub-frame display positions using the shifting parameters 510 identified at 614, thereby producing displayed image 14. The method 600 then returns to 602 to receive and process the next high-resolution image frame 28.

In one embodiment, rather than modifying the sub-frame generation process and sub-frame shifting parameters for each individual image frame 28, the method 600 is applied to groups of frames 28. It will be understood that one or more of the steps in method 600 may be performed only once or at arbitrary times, such as the entry of user-defined parameters at 606, rather than being repeated for every image frame 28 or sets of image frames 28.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of displaying an image with a display device, the method comprising:
receiving image data for the image;
identifying sub-frame shifting parameters based on at least one of image characteristics of the image, system status information, and user-defined parameters;
generating a first plurality of sub-frames corresponding to the image data and based on the identified sub-frame shifting parameters; and
displaying the first plurality of sub-frames at a first plurality of spatially offset sub-frame display positions using the identified shifting parameters, thereby producing a displayed image.

2. The method of claim 1, wherein the sub-frame shifting parameters comprise a quantity of sub-frame display positions.

3. The method of claim 1, wherein the sub-frame shifting parameters comprise pattern of movement information.

4. The method of claim 1, wherein the sub-frame shifting parameters comprise locations of the sub-frame display positions.

5. The method of claim 1, wherein the sub-frame shifting parameters comprise shifting speed information.

6. The method of claim 1, wherein the sub-frame shifting parameters comprise duration of sub-frame display.

7. The method of claim 1, wherein the sub-frame shifting parameters comprise a quantity of sub-frames to generate for the received image data.

8. The method of claim 1, wherein the image characteristics include at least one of resolution, spatial frequency, brightness, and amount of motion.

9. The method of claim 1, wherein the system status information includes at least one of defective pixel information, sub-frame display distortion information, drift information representing an amount of drift of sub-frame display positions, pixel shape information, and display conditions.

10. The method of claim 1, wherein the user-defined parameters include at least one of a desired sharpness of the displayed image, a desired quantity of sub-frame display positions, and a desired number of pixels in the displayed image.

11. The method of claim 1, and further comprising:
identifying at least one sub-frame generation algorithm based on at least one of the image characteristics of the image, the system status information, and the user-defined parameters, and wherein the first plurality of sub-frames are generated using the identified at least one sub-frame generation algorithm.

12. A system for displaying an image, the system comprising:
a device adapted to receive image data for an image;
an image processing unit configured to identify at least one sub-frame generation algorithm based on at least one of image characteristics of the image, system status information, and user-defined parameters, the image processing unit configured to define a first set of sub-frames corresponding to the image data using the identified at least one sub-frame generation algorithm; and
a display device adapted to display the first set of sub-frames at a first set of spatially offset sub-frame display positions, thereby producing a displayed image.

13. The system of claim 12, wherein the image characteristics include at least one of resolution, spatial frequency, brightness, and amount of motion.

14. The system of claim 12, wherein the system status information includes at least one of defective pixel information, sub-frame display distortion information, drift information representing an amount of drift of sub-frame display positions, pixel shape information, and display conditions.

15. The system of claim 12, wherein the user-defined parameters include a desired sharpness of the displayed image.

16. The system of claim 12, wherein the system is configured to identify sub-frame shifting parameters based on at least one of the image characteristics of the image, the system status information, and the user-defined parameters, and wherein the sub-frame shifting parameters comprise at least one of a quantity of sub-frame display positions, pattern of movement information, locations of the sub-frame display positions, shifting speed information, duration of sub-frame display, and quantity of sub-frames.

17. A method of generating low resolution sub-frames for display at spatially offset positions to generate the appearance of a high resolution image, the method comprising:
receiving a high resolution image;
identifying sub-frame shifting parameters and at least one sub-frame generation algorithm based on at least one of image characteristics of the high resolution image, system status information, and user-defined parameters; and
generating a first plurality of pixel values for a first plurality of low resolution sub-frames based on the high resolution image, the identified shifting parameters, and the identified at least one sub-frame generation algorithm.

18. The method of claim 17, wherein the image characteristics include at least one of resolution, spatial frequency, brightness, and amount of motion.

19. The method of claim 17, wherein the system status information includes at least one of defective pixel information, sub-frame display distortion information, drift information representing an amount of drift of sub-frame display positions, pixel shape information, and display conditions.

20. The method of claim 17, wherein the user-defined parameters include a desired sharpness of displayed images.
